(19) United States
(12) Patent Application Publication
(10) Pub. No.: US 2015/0140465 A1
(43) Pub. Date: May 21, 2015

(54) DEVICE FOR SUPPLYING AT LEAST ONE FUEL CELL

(71) Applicant: AREVA Stockage d'Energie, Aix en Provence (FR)

(72) Inventor: Thierry Geneston, Cavaillon (FR)

(21) Appl. No.: 14/413,649

(22) PCT Filed: Jul. 10, 2013
(86) PCT No.: PCT/EP2013/064536

§ 371 Date: Jan. 8, 2015

(30) Foreign Application Priority Data
Jul. 10, 2012 (FR) 1256639

(51) Int. Cl. H01M 8/04

(52) U.S. Cl. CPC H01M 8/04104
USPC 429/446

(57) ABSTRACT

A supply device for supplying at least one fuel is provided. The supply device includes a first fluid circuit and a second fluid circuit, the former to supply the/each fuel cell with fuel and the latter to supply the/each fuel cell with combustion agent. The first circuit includes a first supply line having a first solenoid valve and a first starter configured to allow for the circulation of fluid in the first circuit towards the/each fuel cell when the electrical control of the first solenoid valve is inoperative. The second circuit includes a second supply line having a second solenoid valve and a second starter configured to allow for the circulation of fluid in the second circuit towards the/each fuel cell when the electrical control of the second solenoid valve is inoperative. The supply device includes at least one pressure-actuated reducer arranged on the first circuit and actuated by a pressure in the second circuit.

This invention concerns the field of fuel cells, in particular a device for supplying at least one fuel cell with fuel and combustion agent.

### BACKGROUND

A fuel cell allows electrical energy to be generated by an electrochemical redox reaction between a fuel, e.g., hydrogen, and a combustion agent, e.g., oxygen. Proton Exchange Membrane Fuel Cells (PEMFC) comprise at least one electrochemical cell, whereby each electrochemical cell comprises a proton exchange membrane and allows for the circulation of oxygen on one side of the membrane and hydrogen on the other side of the membrane to cause redox between the hydrogen and the oxygen through the membrane.

Fuel cells are used, e.g., as an electrical energy source in the event of the failure of a power grid in order to supply buildings or sensitive facilities, e.g., hospitals.

Such a fuel cell remains inactive for long periods of time and must be able to be started reliably.

It is possible to provide electrical energy storage devices, such as batteries, capacitors, or supercapacitors, or mechanical energy storage devices such as inertia wheels or pressurised air sources to supply the energy necessary to start the fuel cell.

Nonetheless, the long periods of inactivity of a fuel cell used as an emergency power source makes it necessary to maintain this equipment. Additionally, this equipment may itself be a source of malfunctions.

### SUMMARY OF THE INVENTION

One of the objectives of the invention is to provide a device for supplying at least one fuel cell that allows for the reliable start-up of the fuel cell.

A device for supplying at least one fuel cell is provided, comprising a first fluid circuit and a second fluid circuit, one to supply the/each fuel cell with fuel and the other to supply the/each fuel cell with combustion agent. The first circuit comprises a first supply line having a first electrically controlled solenoid valve that supplies at least one first supply branch, whereby each first supply branch supplies one respective fuel cell, and a first starter configured to allow for the circulation of fluid in the first circuit towards the/each fuel cell when the electrical control of the first solenoid valve is inoperative. The second circuit comprises a second supply line having a second electrically controlled solenoid valve that supplies at least one second supply branch, whereby each second supply branch supplies one respective fuel cell, and a second starter configured to allow for the circulation of fluid in the second circuit towards the/each fuel cell when the electrical control of the second solenoid valve is inoperative. The supply device comprises at least one pressure-actuated pressure reducer arranged on the first circuit and actuated by a pressure in the second circuit.

According to other embodiments, the supply device comprises one or more of the following characteristics, taken alone or in all combinations technically possible:
the first solenoid valve has a first actuation member constituting the first starter, whereby the first solenoid valve can be controlled manually using the first actuation member;
the second solenoid valve has a second actuation member constituting the second starter, whereby the second solenoid valve can be manually using the actuation member;
the first starter comprises a first bypass line for the first solenoid valve comprising a first bypass valve;
the first bypass valve is controlled electrically or manually, and can be controlled by means of a first actuation member;
the first supply line supplies several first supply branches, and the first bypass line opens into the first supply line;
the first supply line supplies several first supply branches, and the first bypass line supplies several first bypass branches, whereby each first bypass branch opens into a respective first supply line;
the second starter comprises a second bypass line for the second solenoid valve having a second bypass valve that is manually controlled and can be controlled by means of the second actuation member;
the second bypass valve is controlled electrically or manually, and can be controlled by means of a second actuation member;
the second supply line supplies several second supply branches, and the second bypass line opens into the second supply line;
the second supply line supplies several second supply branches, and the second bypass line supplies several second bypass branches, whereby each second bypass branch opens into a respective second supply line;
it comprises at pressure-actuated pressure reducer arranged on the first supply line and actuated by a control pressure obtained in the second supply line;
it comprises at pressure-actuated pressure reducer arranged on the first bypass line and actuated by a control pressure obtained in the second supply line;
it comprises at pressure-actuated pressure reducer arranged on the first bypass line and actuated by a control pressure obtained in the second bypass line;
it comprises at pressure-actuated pressure reducer arranged on a first bypass branch and actuated by a control pressure obtained in a second bypass branch, whereby the first bypass branch and the second bypass branch preferably supply the same fuel cell;
it comprises a pressure-actuated pressure reducer arranged on a first supply branch and actuated by a control pressure obtained in a second supply branch, whereby the first supply branch and the second supply branch preferably supply the same fuel cell;
it comprises a controlled pressure reducer arranged on the second supply line;
it comprises a controlled pressure reducer arranged on the second bypass line;
it comprises a controlled pressure reducer arranged on the second supply branch;
it comprises at least one controlled pressure reducer arranged on a second supply branch;
it comprises an electrically controlled pressure regulator arranged on the first supply line, preferably upstream of the first point of return of the first bypass line in the first supply line;
it comprises an electrically controlled pressure regulator arranged on the second supply line, preferably upstream of the second point of return of the second bypass line in the second supply line;
it comprises an electrically controlled pressure regulator arranged on each first supply branch, preferably upstream of the first point of return of the first bypass branch in the first supply branch;
it comprises an electrically controlled pressure regulator arranged on each second supply branch, preferably upstream of the second point of return of the second bypass branch in the second supply branch.

The invention also concerns a fuel cell system comprising at least one fuel cell and a device for supplying the/each fuel cell with fuel and combustion agent as defined above.

### BRIEF SUMMARY OF THE DRAWINGS

The invention and its benefits will be better understood based on the following description, provided by way of example only, referring to the attached drawings, in which:

FIG. 1 is a schematic detail view of a fuel cell system comprising a supply device;

FIGS. 2-4 are views analogous to that of FIG. 1 showing fuel cell systems comprising supply devices according to variants.

### DETAILED DESCRIPTION

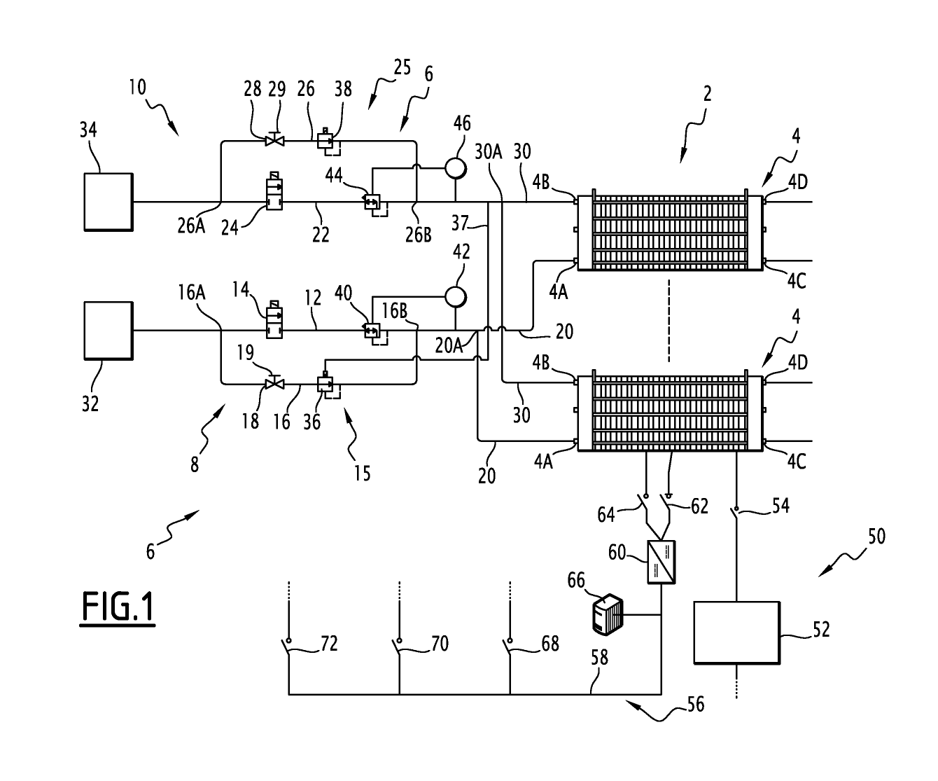

The fuel cell system 2 shown in FIG. 1 comprises a plurality of fuel cells 4 and a supply device 6 to supply each fuel cell with fuel and combustion agent. Only two fuel cells 4 are shown in FIG. 1.

Each fuel cell 4 comprises at least one electrochemical cell and, preferably, a stack of electrochemical cells, each of which is configured to generate electricity by redox of a fuel and a combustion agent.

Each fuel cell 4 comprises a first input 4A and a second input 4B, the former to supply fuel and the latter to supply combustion agent. Each electrochemical cell is supplied with fuel and combustion agent via the first input 4A and the second input 4B.

Each fuel cell 4 comprises a first output 4C and a second output 4D to drain the fluids resulting from the redox reaction.

The fuel cells 4 are, e.g., proton exchange membrane fuel cells (PEMFC). Each electrochemical cell comprises a proton exchange membrane, whereby the redox reaction is carried out by proton exchange via the membrane between hydrogen, used as fuel, and oxygen, used as a combustion agent.

Preferably, the fuel cells are hydrogen/oxygen (H₂/O₂) cells using hydrogen (H₂) as the fuel and oxygen (O₂) as the combustion agent. There are hydrogen/air fuel cells that use hydrogen (H2) as the fuel and oxygen from air as the combustion agent. The redox reaction generates water due to the combination of oxygen and hydrogen.

The supply device comprises a first fluid circuit 8 and a second fluid circuit 10, the former to supply the fuel cells 4 with fuel and the latter to supply the fuel cells 4 with combustion agent. The first circuit 8 is used to supply fuel, and the second circuit 10 is used to supply combustion agent, or vice versa.

The first circuit 8 supplies the first inputs 4A of the fuel cells 4, and the second circuit 10 supplies the second inputs 4B of the fuel cells 4.

The first circuit 8 comprises a first supply line 12 having a first solenoid valve 14 to control the flow rate in the first supply line 12, and a first starter 15 configured to allow for the circulation of fluid in the first circuit 8 towards each fuel cell 4 when the electrical control of the first solenoid valve 14 is inoperative.

The first starter 15 comprises a first bypass line 16 for the first solenoid valve 14 having a first bypass valve 18 to control the flow rate in the first bypass line 16.

The first solenoid valve 14 is electrically controlled and requires an electrical power supply in order to operate. Its electrical control is inoperative in the absence of electrical power. In normal operation, the electrical control of the first solenoid valve 14 is supplied with electricity by the/each fuel cell.

The first bypass valve 18 is manually controlled and requires no electrical power supply in order to operate. It comprises a first actuation member 19, which, when manually actuated by an operator, closes the second bypass valve 18 to prevent the circulation of fluid in the second bypass line 16 or opens the second bypass valve 18 to allow the circulation of fluid in the second bypass line 16.

The first circuit 8 comprises at least one first supply branch 20 supplied by the first supply line 12, whereby each first supply branch 20 is linked to the first input 4A of a respective fuel cell 4 to supply the fuel cell 4.

The first circuit 8 comprises as many first supply branches 20 as the fuel cells 4 comprised by the fuel cell system 2. The first inputs 4A of the fuel cells 4 are supplied simultaneously by the first circuit 8.

The first bypass line 16 is supplied from the first supply line 12 upstream of the first solenoid valve 14 at a first supply point 16A, and opens into the first supply 12 at a first point of return 16B downstream of the first solenoid valve 14 and upstream of the junction of the first branches 20 on the first supply line 12.

The second circuit 10 comprises a second supply line 22 having a second solenoid valve 24 to control the flow rate in the second supply line 22, and a second starter 25 configured to allow for the circulation of fluid in the second circuit 10 towards the/each fuel cell 4 when the electrical control of the second solenoid valve 24 is inoperative.

The second starter 25 comprises a second bypass line 26 for the second solenoid valve 24 having a second bypass valve 28 to control the flow rate in the second bypass line 26.

The second solenoid valve 24 is electrically controlled and requires an electrical power supply in order to operate. Its electrical control is inoperative in the absence of electrical power. In normal operation, the electrical control of the second solenoid valve 24 is supplied with electricity by the/each fuel cell.

The second bypass valve 28 is manually controlled and requires no electrical power supply in order to operate. It comprises a second actuation member 29, which, when manually actuated by an operator, closes the second bypass valve 28 to prevent the circulation of fluid in the second bypass line 26 or opens the second bypass valve 28 to allow the circulation of fluid in the second bypass line 26.

The second circuit 10 comprises at least one second supply branch 30 supplied by the second supply line 22, whereby each second branch 30 is linked to the second input 4B of a respective fuel cell 4 to supply the fuel cell.

The second circuit 10 comprises as many second supply branches 30 as the fuel cells 4 comprised by the fuel cell system 2. The second inputs 4B of the fuel cells 4 are supplied simultaneously by the second circuit 10.

The second bypass line 26 is supplied from the second supply line 22 upstream of the second solenoid valve 24 at a second supply point 26A, and opens into the second supply 22 at a second point of return 26B downstream of the second solenoid valve 14 and upstream of the junction of the second supply branches 30 on the second supply line 22.

The first supply line 12 is supplied from a first source 32, and the second supply line 22 is supplied from a second source 34. One of the first source 32 and the second source 34 is a source of hydrogen, and the other is a source of oxygen, or, in one variant, a source of air.

The supply device 6 comprises a pressure-actuated pressure reducer 36 arranged on the first bypass line 16 and actuated by the pressure in the second supply line 22.

A pressure-actuated pressure reducer depressurises the gas in the line in which it is arranged using a control pressure obtained from the other line as a reference pressure. The pressure-actuated pressure reducer is actuated in open loop.

The pressure-actuated pressure reducer 36 is controlled by the pressure obtained from the second supply line 22 downstream of the point of return of the second bypass line 26 in the second supply line 22 and upstream of the junction of the second supply branches 30 on the second supply line 22.

The pressure-actuated reducer 36 comprises a pressure tap 37 that obtains the control pressure from the second supply line 22 downstream of the point of return of the second bypass line 26 in the second supply line 22 and upstream of the junction 30A of the second supply branches 30 on the second supply line 22.

The supply device 6 comprises a controlled pressure reducer 38 arranged on the second bypass line 26 downstream of the second bypass valve 28.

A controlled pressure reducer depressurises the gas in the line on which it is arranged based on instructions given, e.g., by the ambient pressure or a pressure setting determined by the position of a controlled adjuster. The controlled pressure reducer is controlled electrically and/or manually independently of the pressure on another line.

The first circuit 8 comprises a first electrically controlled pressure regulator 40 arranged on the first supply line and associated with a first pressure sensor 42 arranged on the first supply line.

An electrically controlled pressure regulator regulates the gas pressure on the line on which it is arranged depending on the pressure reading signal supplied by the associated pressure sensor by actuating a pressure regulation member using an electrical actuator. The pressure sensor is preferably arranged on the line for closed-loop regulation.

The first electrically controlled pressure regulator 40 is arranged on the first supply line 12 between the supply point and the point of return of the first bypass line 16. The first electrically controlled pressure regulator 40 is arranged downstream of the first solenoid valve 14.

The first pressure sensor 42 is arranged on the first supply line 12 downstream of the point of return of the first bypass line 16 and upstream of the junction 20A on the first supply branches 20 on the first supply line 12.

The second circuit 10 comprises a second electrically controlled pressure regulator 44 arranged on the second supply line 22 and associated with a second pressure sensor 46 arranged on the second supply line.

The second electrically controlled pressure regulator 44 is arranged on the second supply line 22 between the supply point and the point of return of the second bypass line 26. The second electrically controlled pressure regulator 44 is arranged downstream of the second solenoid valve 24.

The second pressure sensor 46 is arranged on the second supply line 22 downstream of the point of return of the second bypass line 26 and upstream of the junction 30A on the second supply branches 30.

The fuel cell system 2 comprises an electricity delivery device 50 to deliver the electricity produced by the fuel cells, e.g., to an electrical installation, an electrical device, or a power grid.

The delivery device 50 comprises a power converter 52 linked electrically to the electrical terminals of the fuel cells 4 via an output contactor 54, and, if applicable, via a first electric converter (not shown).

The fuel cell system 2 comprises a controller 56 to control the electrical and electromechanical actuators of the fuel cell system 2, including the solenoid valves, the controlled pressure reducer when they are under electrical control, and the electrically controlled pressure regulators.

The controller comprises a control network 58, electrically linked to the electrical terminals of the fuel cells via an electric converter 60, whereby the converter 60 itself is linked to the fuel cells 4 via a manually controlled switch 62 and an electrically controlled switch 64 arranged in parallel between the converter 60 and the fuel cells 4.

The control device 56 comprises a control unit 66 that is supplied with electrical energy on the control network 58, a starting contactor 68 via which the starting actuators are supplied on the control network 58, a stop switch 70 via which the stop actuators are supplied on the control network 58, and an additional contactor 72 via which additional actuators are supplied on the control network 58.

The starting actuators are necessary in order to start the fuel cell in the initial phase of start-up. The stop actuators are necessary in order to stop the fuel cells 4. The additional actuators are not directly involved in the start-up or shutdown of the fuel cell system 2.

The control unit 66 is configured so as to control the various switches and actuators, including the electrically controlled pressure reducer, the electrically controlled pressure regulators, and the electrically controlled valves, in particular the first solenoid valve 14 and the second solenoid valve 24.

In operation, the fuel cells 4 are initially stopped. The first solenoid valve 14 and the second solenoid valve 24 are closed and inoperative due to the absence of a power supply from the fuel cells 4. The switch 62 is open or closed.

To start the fuel cells 4, the first bypass valve 18 and the second bypass valve 28 are open, preferably simultaneously. Due to the pressure differential, which is greater at the first source 32 and the second source 34 than at the fuel cells 4, the fuel and the combustion agent circulate from the sources to the fuel cells 4, passing through the first bypass line 16 and the second bypass line 26. The fuel and combustion agent enter into the fuel cells 4. The redox reaction begins in the fuel cells 4, which begin to generate electricity.

If the switch 62 is open, it is then closed manually; otherwise, it remains closed. Once the control unit 66 is supplied with electrical energy and the power supply is sufficient on the control network 58, it closes at least the starting contactor 68 so as to supply power to the actuators necessary to start the fuel cells. The starting contactor 68 supplies, in particular, the first solenoid valve 14, the second solenoid valve 24, the electrically controlled pressure regulators 40, 44, and the associated pressure sensors 42, 46.

Then, the control unit 66 closes the stop switch 70 and the additional contactor 72 to supply all of the actuators of the fuel cell system 2 by means of the electrical energy produced by the fuel cells 4 in order to allow for the normal operation of the fuel cell system 2.

Preferably, the control unit 66 is supplied by manually closing the switch 62. Once the control unit 66 is supplied with electrical energy, and determines that the power supply is sufficient on the control network 58, it closes the contactor 64 that is arranged in parallel. An operator then manually opens the switch 62. The bypass valves 18 and 28 may then be closed; the fuel and combustion agent pass directly through the solenoid valves 14 and 24.

The supply of the actuators of the fuel cell system 2, and, in particular, that of the solenoid valves, the electrically controlled pressure reducers, and the electrically controlled pressure elements allows the fuel cell system 2 to operate autonomously in terms of power supply.

The first circuit and the second circuit allow for controlled supply of the fuel cells with fuel and combustion agent, with reliable, safe start-up.

Below, the reference numerals for elements similar to those of FIG. 1 are maintained.

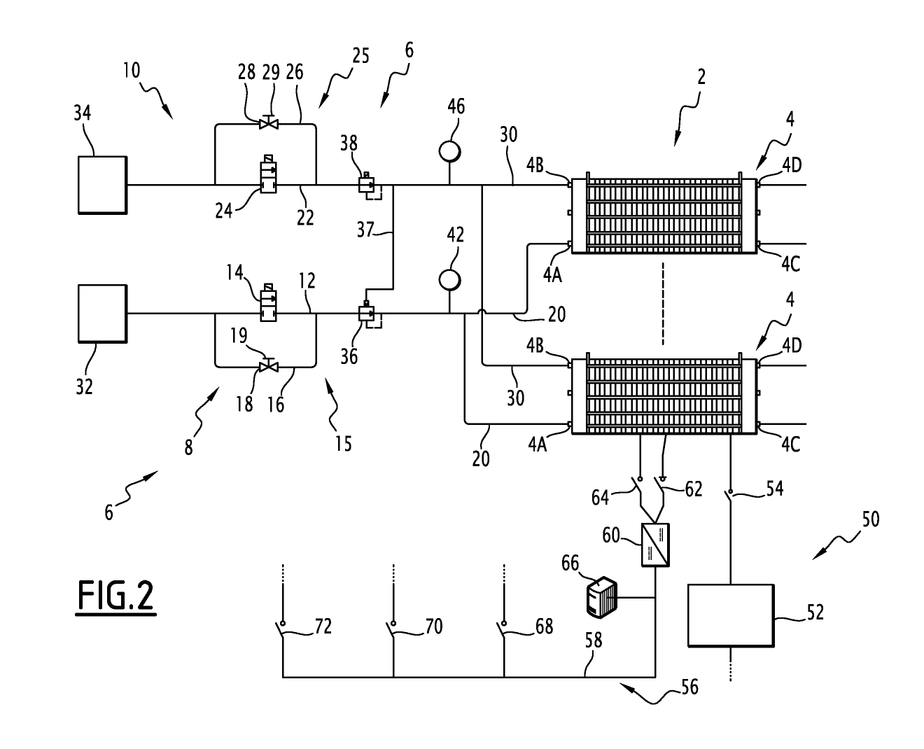

The fuel cell system 2 of FIG. 2 differs from that of FIG. 1 in that the controlled pressure reducer 38 of the second circuit 10 is arranged on the second supply line 22 downstream of the point of return of the second bypass line 26 and upstream of the second supply branches 30.

The pressure-actuated pressure reducer 36 of the first circuit 8 is arranged on the first supply line 12 downstream of the point of return of the first bypass line 16 and upstream of the first supply branches 20.

The pressure tap 37 is arranged on the second supply line 22 downstream of the controlled pressure reducer 38 and upstream of the second supply branches 30.

The first circuit 8 comprises a first pressure sensor 42 arranged between the pressure-actuated pressure reducer and the first branches. The second circuit includes a second pressure sensor 46 arranged between the pressure tap and the second branches. Furthermore, the first supply circuit and the second supply circuit do not have an electrically controlled pressure regulator.

The first bypass line 16 and the second bypass line 26 do not include a pressure reducer. Only the first bypass valve 18 is arranged on the first bypass line 16, and only the second bypass valve 28 is arranged on the second bypass line 26.

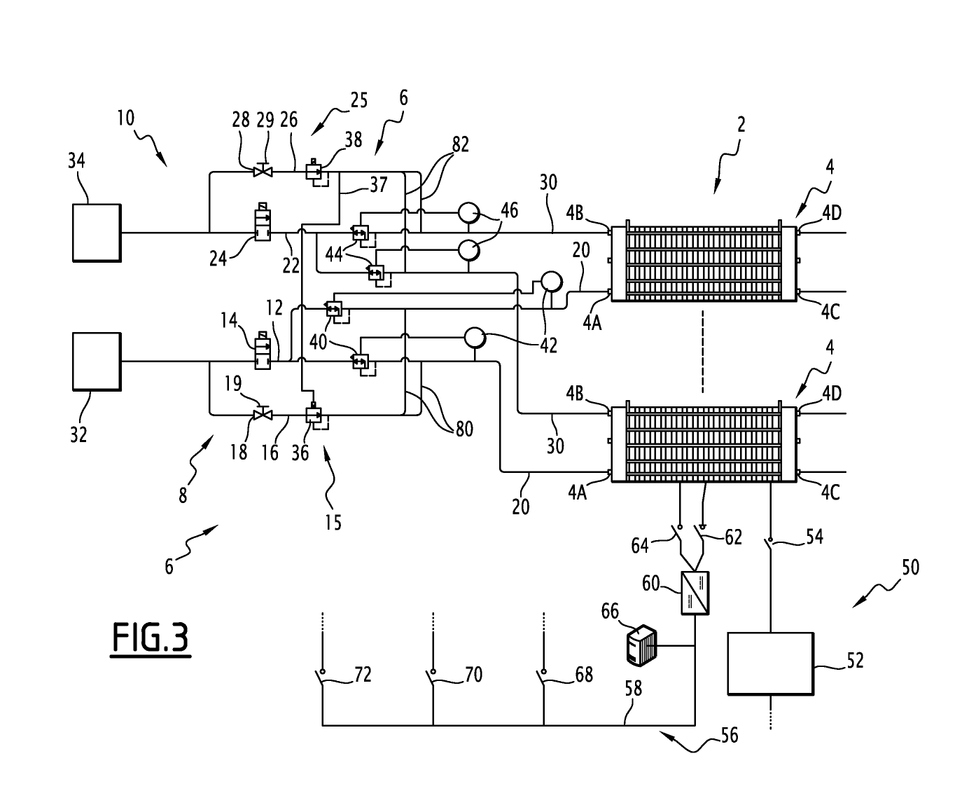

In the fuel cell system 2 of FIG. 3, the first starter 15 comprises a plurality of first bypass branches 80 that are supplied from the first bypass line 16, whereby each first bypass branch 80 opens into a respective first supply branch 20.

The second starter 25 comprises a plurality of second bypass branches 82 that are supplied from the second bypass line 26, whereby each second bypass branch 82 opens into respective second supply branch 30.

The pressure-actuated pressure reducer 36 is arranged on the first bypass line 16 downstream of the first bypass valve 18, and is actuated by a pressure obtained from the second bypass line 26 upstream of the second bypass branches 82. The controlled pressure reducer 38 is arranged on the second bypass line 26 downstream of the second bypass valve 26. The pressure tap 37 is arranged downstream of the controlled pressure reducer 38 and upstream of the second supply branches 82.

On each first supply branch, the first circuit 8 comprises a first electrically controlled pressure regulator 40 arranged upstream of the point of return of the associated first bypass branch 80, and associated with a respective first pressure sensor 42, arranged on the first supply branch 20 downstream of the point of return of the associated first bypass branch 80.

Likewise, the second circuit 10 comprises a second electrically controlled pressure regulator 44 on each second supply branch 30 arranged upstream of the point of return of the associated first bypass branch 82, and associated with a respective second pressure sensor 46, arranged on the second supply branch 30 downstream of the point of return of the associated second bypass branch 82.

In this variant, the controlled pressure reducer 38 and the pressure-activated pressure reducer 36 adjust the pressure in the bypass lines common to the fuel cells upstream of the dedicated bypass branches. Each supply branch comprises a pressure regulator to individually regulate the fuel or combustion agent pressure delivered to each fuel cell.

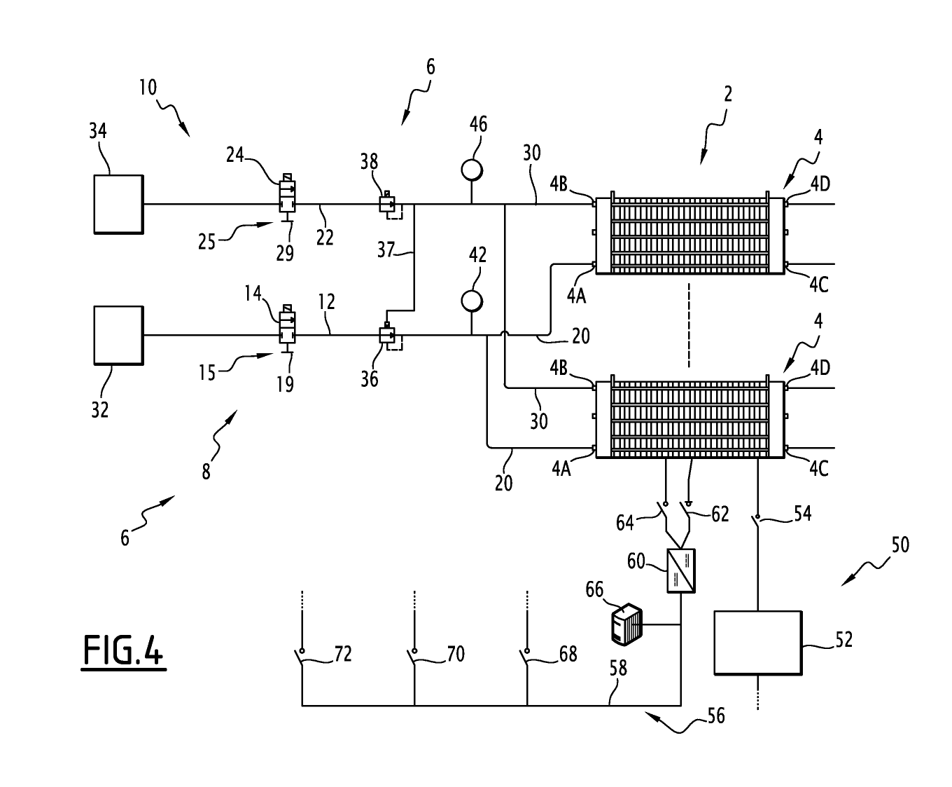

The fuel cell system of FIG. 4 differs from that of FIG. 2 in that it lacks a first bypass line with a first bypass valve, and a second bypass line with a second bypass valve.

The first solenoid valve 14 has a manually actuated first actuation member 19 that opens the first solenoid valve 14 when the electrical control of the first solenoid valve 14 is inoperative. The manually controlled first actuation member 19 constitutes the first starter 15.

Likewise, the second solenoid valve 24 has a manually actuated second actuation member 29 that opens the second solenoid valve 24 when the electrical control of the first solenoid valve 24 is inoperative. The manually controlled second actuation member 29 constitutes the second starter 25.

Other variants are possible.

In one variant of the fuel cell system of FIG. 1, only the first pressure regulator 40 common to the fuel cells is replaced by a respective dedicated first pressure regulator for each fuel cell, whereby each first pressure regulator 40 is arranged on a respective first supply line and associated with a pressure sensor 42, as is the case, for example, in the variant of FIG. 3.

In one variant of the fuel cell system of FIG. 1, only the second pressure regulator 44 common to the fuel cells is replaced by a respective dedicated second pressure regulator for each fuel cell, whereby each second pressure regulator 44 is arranged on a respective second supply line and associated with a pressure sensor 46, as is the case, for example, in the variant of FIG. 3.

In one variant of the fuel cell system of FIG. 2 or 4, and based on the same principle as FIG. 3, the first pressure reducer 36 common to the fuel cells is replaced by a respective dedicated first pressure for each fuel cell, whereby each first pressure reducer 36 is arranged on a respective first supply branch and associated with a pressure sensor 42, as is the case, for example, in the variant of FIG. 3. Alternatively, or as another variant, the second pressure reducer 38 common to the fuel cells 4 is replaced by a respective dedicated second pressure reducer for each fuel cell, whereby each second pressure reducer 38 is arranged on a respective first supply branch and associated with a pressure sensor 46, as is the case, for example, in the variant of FIG. 3.

In the various variants above, the first bypass valve and the second bypass valve are, for example, manually controlled, allowing for manual start-up of the fuel cell in the absence of any electrical power supply, e.g., provided by an electrical energy storage device.

In one variant, the first bypass valve and the second bypass valve are electrically controlled and supplied by an electrical energy storage device. In this case, they may be actuated with low power, and an low-capacity electrical energy storage device will suffice, thus reducing the size of this storage device. Manual start-up remains possible.

Optionally, in order to allow for simultaneous control, the first bypass valve and the second bypass valve, whether they are controlled manually or electrically, are linked by a synchronisation mechanism.

Furthermore, in the various variants, it is possible to link the control network directly to the fuel cells without providing a switch and contactor, as shown in FIGS. 1-4. In such a case, the control unit is supplied with electrical energy and controls the opening and closing of the starting contactors, stop switches, and/or additional contactors once the electrical energy supplied by the fuel cells is sufficient.

The various variants were described for a fuel cell system comprising several fuel cells that are supplied simultaneously by the supply device.

In one variant, the fuel cell system comprises a single fuel cell, whereby the supply device is adapted accordingly; in this case, the first circuit and the second circuit each comprise a single supply branch.

What is claimed is:

1-20. (canceled)

21. A device for supplying at least one fuel cell comprising:
a first fluid circuit and a second fluid circuit, one to supply the or each fuel cell with fuel and the other to supply the or each fuel cell with combustion agent,
the first circuit including a first supply line having a first electrically controlled solenoid valve that supplies at least one first supply branch, each first supply branch supplying one respective fuel cell, the first circuit including a first starter configured to allow for circulation of fluid in the first circuit towards the or each fuel cell when electrical control of the first solenoid valve is inoperative,
the second circuit including a second supply line having a second electrically controlled solenoid valve that supplies at least one second supply branch, each second supply branch supplying one respective fuel cell, the second circuit including a second starter configured to allow for circulation of fluid in the second circuit towards the or each fuel cell when electrical control of the second solenoid valve is inoperative; and
at least one pressure-actuated pressure reducer arranged on the first circuit and actuated by a pressure in the second circuit.

22. The supply device as recited in claim 21 wherein the first solenoid valve has a first actuation member constituting the first starter, the first solenoid valve being controllable manually using the first actuation member.

23. The supply device as recited in claim 21 wherein the second solenoid valve has a second actuation member constituting the second starter, the second solenoid valve being controllable manually using the second actuation member.

24. The supply device as recited in claim 21 wherein the first starter includes a first bypass line for the first solenoid valve, the first bypass line having a first bypass valve.

25. The supply device as recited in claim 24 further comprising a pressure-actuated pressure reducer arranged on the first bypass line and actuated by a control pressure obtained in the second supply line.

26. The supply device as recited in claim 24 further a pressure-actuated pressure reducer arranged on the first bypass line, the second starter includes a second bypass line for the second solenoid valve, the pressure-actuated pressure reducer being actuated by a control pressure obtained in the second by-pass line.

27. The supply device as recited in claim 21 wherein the second starter includes a second bypass line for the second solenoid valve, the second bypass line having a second bypass valve.

28. The supply device as recited in claim 27 further comprising a controlled pressure reducer arranged on the second bypass line.

29. The supply device as recited in claim 27 further comprising a controlled pressure reducer arranged on the second supply branch.

30. The supply device as recited in claim 21 further comprising a pressure-actuated pressure reducer arranged on the first supply line and actuated by a control pressure obtained in the second supply line.

31. The supply device as recited in claim 21 wherein the first starter includes a first bypass line for the first solenoid valve having a first bypass valve, the second starter including a second bypass line for the second solenoid valve having a second bypass valve, the second supply line supplying several second supply branches, the second bypass line supplying several second bypass branches, each second bypass branch opening into a respective second supply line, the supply device including a pressure-actuated pressure reducer arranged on a first bypass branch and actuated by a control pressure obtained in one of the second bypass branches.

32. The supply device as recited in claim 31 wherein the first bypass branch and the one of the second bypass branches supply the same fuel cell.

33. The supply device as recited in claim 21 further comprising a pressure-actuated pressure reducer arranged on a first supply branch and actuated by a control pressure obtained in a second supply branch, the first supply branch and the second supply branch supplying the same fuel cell.

34. The supply device as recited in claim 21 further comprising a controlled pressure reducer arranged on the second supply line.

35. The supply device as recited in claim 21 wherein the second supply line supplies several second supply branches, the supply device comprising at least one controlled pressure reducer arranged on one of the second supply branches.

36. The supply device as recited in claim 21 further comprising an electrically controlled pressure regulator arranged on the first supply line.

37. The supply device as recited in claim 21 further comprising an electrically controlled pressure regulator arranged on the second supply line.

38. The supply device as recited in claim 21 further comprising an electrically controlled pressure regulator arranged on each first supply branch.

39. The supply device as recited in claim 21 further comprising an electrically controlled pressure regulator arranged on each second supply branch.

40. A fuel cell system comprising:
at least one fuel cell; and
the supply device as recited in claim 21 for supplying the or each fuel cell with fuel and combustion agent.
